(19) United States
(12) Patent Application Publication
(10) Pub. No.: US 2011/0224962 A1
(43) Pub. Date: Sep. 15, 2011

(54) Electrophysiologic Testing Simulation For Medical Condition Determination

(76) Inventors: Jeffrey Goldberger, Skokie, IL (US); Jason Ng, Evanston, IL (US)

(21) Appl. No.: 12/972,718

(22) Filed: Dec. 20, 2010

Related U.S. Application Data
(60) Provisional application No. 61/312,405, filed on Mar. 10, 2010.

(51) Int. Cl. G06G 7/60

(52) U.S. Cl. 703/11

(57) ABSTRACT

A system simulates stimulation of scar tissue identified as hyper-enhanced areas in a medical image with variable luminance thresholds and categorizes partially-viable myocardium as distinct from non-viable scar tissue. A cardiac function analysis system includes a repository of imaging data representing a 3D volume comprising a patient heart. A model processor provides a model of the patient heart using the imaging data said model being for use in allocating electrical properties to model parameters determining electrical conductivity associated with image data classified as, (a) scar tissue, (b) impaired tissue and (c) normal heart tissue. The electrical properties allocated to scar tissue are different to electrical properties allocated to normal tissue. A stimulation processor simulates electrical stimulation of the patient heart using the model to identify risk of heart impairment.

This is a non-provisional application of provisional application Ser. No. 61/312,405 filed 10 Mar., 2010, by J. Goldberger et al.

This invention was made with government support under Grant Number R21 HL094902 awarded by the National Institutes of Health. The government has certain rights in the invention.

### FIELD OF THE INVENTION

This invention concerns a system for cardiac function analysis to identify risk of heart impairment by simulating electrical stimulation of a patient heart using a model derived by allocating electrical properties associated with electrical conductivity to automate heart characterization using imaging.

### BACKGROUND OF THE INVENTION

Sudden cardiac death (SCD) is a major health issue faced in the United States affecting an estimated 180,000 to over 400,000 people a year. SCD is most commonly defined as unexpected death due to loss of cardiac function, characterized by abrupt loss of consciousness within an hour of the onset of acute symptoms. Most SCDs are due to arrhythmias, namely ventricular tachycardia or ventricular fibrillation. Multiple studies have demonstrated that the survival from out of hospital cardiac arrest is poor. The incidence of SCD is significantly reduced in high risk patients treated prophylactically with an implantable cardioverter defibrillator (ICD). Thus, the ability to identify at risk patients prior to having a cardiac arrest is critical. Known systems identify populations that are at higher risk for SCD, but lack the ability to accurately discriminate the low risk group from the high risk group.

Electrical mapping and pacing during animal and clinical studies indicates that ventricular tachyarrhythmias following myocardial infarction (MI) are often macroreentrant circuits around the infarct scars. These circuits can be complex, containing areas of slow conduction and multiple pathways of reentry. Some of the pathways may be critical while others may simply be bystander circuits of reentry which when interrupted through ablation do not terminate the arrhythmia. Risk stratification for prevention of sudden cardiac death is an important clinical problem. There are 180,000-400,000 sudden cardiac deaths annually in the United States. There are excellent treatments to provide patients who are at risk. However, available testing cannot reliably identify a substantial portion of those at risk.

It is known that magnetic resonance imaging (MRI) with contrast can be used to detect scarring after myocardial infarction and that size of an infarct scar and the amount of partially viable areas (termed “gray zones”) determined by MRI correlate to the inducibility of VT using programmed stimulation otherwise known as electrophysiologic testing. Electrophysiologic testing involves the placement of catheters within the heart and stimulation to induce a rapid, potentially dangerous heart rhythm (which is quickly terminated). Those patients with inducible rapid, potentially dangerous heart rhythms are considered at risk and treated with an implantable defibrillator. Recently, contrast enhanced MRI has been developed to outline the anatomic features of a myocardial infarction. A system according to invention principles addresses determining risk of cardiac function impairment and associated problems.

### SUMMARY OF THE INVENTION

A system simulates stimulation of scar tissue identified as hyper-enhanced areas in a medical image (e.g., greater than 3 standard deviations from normal myocardium luminance level) using variable luminance thresholds and categorizes partially-viable myocardium as distinct from non-viable scar tissue. A cardiac function analysis system includes a repository of imaging data representing a 3D volume comprising a patient heart. A model processor provides a model of the patient heart using the imaging data, in allocating electrical properties to model parameters determining electrical conductivity associated with image data classified as, (a) scar tissue, (b) impaired tissue and (c) normal heart tissue. The electrical properties allocated to scar tissue and impaired tissue are different to electrical properties allocated to normal tissue. A stimulation processor simulates electrical stimulation of the patient heart using the model to identify risk of heart impairment.

### BRIEF DESCRIPTION OF THE DRAWING

FIG. 1 shows a cardiac function analysis system, according to invention principles.

FIG. 2 shows a flowchart of a process performed by a cardiac function analysis system to identify patient cardiac function risk, according to invention principles.

FIG. 3 illustrates voltage maps indicating the induction of sustained ventricular tachycardia, according to invention principles.

FIG. 4 shows a table including parameters for a Fenton-Karma Model assigned to normal and impaired myocardium, according to invention principles.

FIG. 5 shows a table indicating volume of left ventricular myocardium, impaired myocardium and completely non-viable scar tissue detected using different luminance intensity threshold levels in imaging data, according to invention principles.

FIG. 6 shows a table of results of induced ventricular tachycardia at different viability thresholds resulting from electrophysiologic testing of seven test subject pigs, according to invention principles.

FIG. 7 shows voltage maps illustrating an example of scar profile at different viability thresholds, according to invention principles.

FIG. 8 shows a graph of restitution curves comprising action potential duration plotted against diastolic interval for simulated electrophysiology, according to invention principles.

FIG. 9 depicts thresholds used within a range of luminance intensities for image processing and detecting selected scar voxels, according to invention principles.

FIG. 10 shows voltage maps indicating induced ventricular tachycardia resulting from electrophysiologic testing of four test subject pigs, according to invention principles.

FIG. 11 shows a flowchart of a process performed by a cardiac function analysis system, according to invention principles.

### DETAILED DESCRIPTION OF THE INVENTION

A system simulates stimulation of scar tissue using a 3D heart model derived from cardiac imaging so that hyper-enhanced areas in a medical image (greater than 3 standard deviations from normal myocardium luminance level) are detected using variable luminance thresholds and partially-viable myocardium is categorized as distinct from non-viable scar tissue. In one embodiment a computer action potential model (e.g., a Fenton-Karma model) is used to simulate activation and conduction in viable zones of a 3D left ventricle (LV) geometry. The system performs computer simulation of cardiac electrophysiology using three-dimensional models obtained by in-vivo MRI and is usable to evaluate whether an infarct is sufficient to support ventricular tachycardia (i.e. virtual electrophysiologic testing).

Mapping of ventricular tachycardias in an electrophysiology laboratory identifies various potential components of a cardiac circuit including a central isthmus, inner loop, and outer loop. Magnetic resonance imaging with contrast is used to detect scarring after myocardial infarction. Although there is some correlation of size of an infarction with the inducibility of ventricular tachycardia, infarct size alone may be insufficient for a risk stratification measure. A system employs computer simulation of cardiac electrophysiology using three-dimensional models obtained by MRI or other types of cardiac imaging to evaluate whether the size, location, and morphology of an infarct is sufficient to support ventricular tachycardia. The system is tested using a pig model of chronic myocardial infarction.

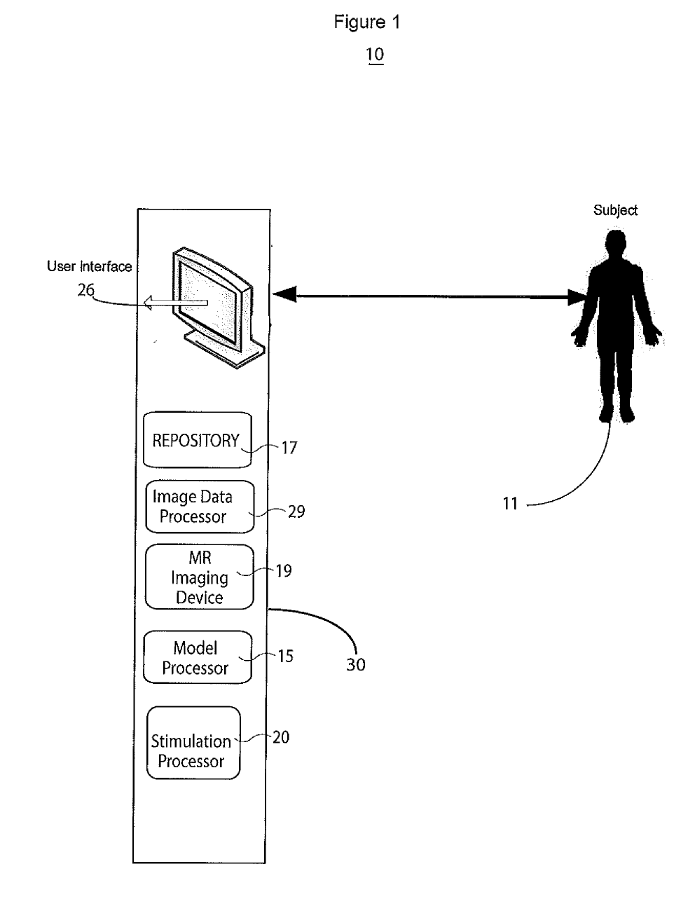

FIG. 1 shows cardiac function analysis system 10 employing one or more computer servers or other processing devices 30 including repository 17, user interface 26, model processor 15, MR imaging device 19, image data processor 29 and stimulation processor 20. System 10 assesses anatomic features in a cardiac medical image indicating myocardial infarction (acquired by MRI or CT, for example) to obtain a 3D model of a patient heart outlining normal myocardium, infarct zones, and mixed zones. System 10 adaptively assigns electrical properties to a normal myocardium, infarct zones and mixed zones based on known models of myocellular electrical activity and performs programmed stimulation on this anatomically correct (for each patient) electro-anatomic model of the heart to identify sustained ventricular arrhythmias. System 10 recognizes that each patient's anatomic distribution of scarring due to myocardial infarction may determine their risk for rapid, potentially dangerous heart rhythms. Features of the infarct are also predictive of rapid, potentially dangerous heart rhythms. System 10 advantageously identifies risk for arrhythmias. User interface 26 displays images and includes a display processor for initiating generation of data representing images for display.

The cardiac function analysis system 10 includes repository 17 of imaging data representing a 3D volume acquired by MR imaging device 19 (or CT scan, Ultrasound, X-ray in another embodiment). Image data processor 29 performs left ventricle image data segmentation and classifies left ventricle MRI voxels. A voxel is a 3D (three dimensional) volume image element comprising one or more pixels. Model processor 15 provides a model of the patient heart using the imaging data and allocates electrical properties to model parameters determining electrical conductivity associated with image data classified as, (a) scar tissue, (b) impaired heart tissue and (c) normal heart tissue. The electrical properties allocated to scar tissue, impaired tissue and normal tissue are individually and mutually different. In one embodiment, model processor 15 allocates electrical properties to model parameters determining electrical conductivity associated with image data classified by, (a) tissue fiber orientation, (b) mural (cavity wall) location (such as epicardium, myocardium or endocardium, for example) and (c) a characteristic of a border zone comprising an area surrounding dense scar, adjacent to normal tissue. Model processor 15 advantageously allocates electrical properties to model parameters determining electrical conductivity associated with image data classified by imaging including specific characteristics of tissue revealed by specialized imaging functions including, cell imaging, gap junction imaging (imaging of Cardiac cells forming gap junctions, for example) and MIBG imaging using meta-iodobenzylguanidine (mIBG) as a cardiac sympathetic innervation imaging agent, for example.

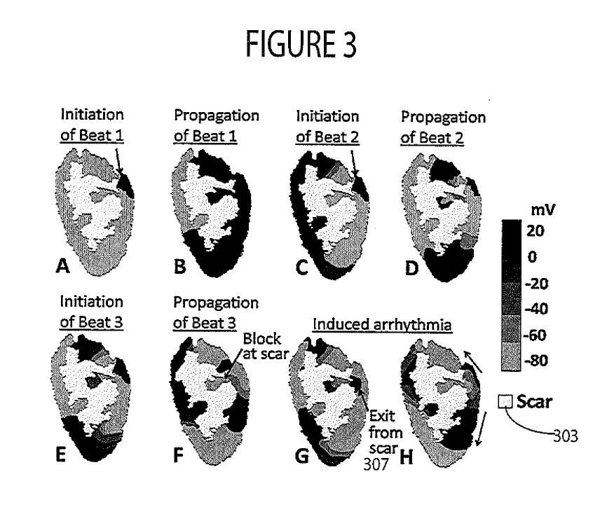

Stimulation processor 20 simulates electrical stimulation of the patient heart using the model to identify risk of heart impairment. FIG. 3 illustrates simulated voltage maps indicating sustained ventricular tachycardia resulting from stimulation by stimulation processor 20. Scar tissue is represented as light gray (gray shade 303). Electrical activation of the induced arrhythmia is shown (e.g., as dark area 307) exiting the upper portion of the scar tissue. The voltage maps shown herein are gray scale representations of color maps with individual color (gray shade) used to represent image areas having a voltage potential within a particular voltage range.

Sustained ventricular tachycardia (VT) following myocardial infarction (MI) is often due to a macroreentrant circuit around scar tissue. System 10 delineates the scar with cardiac MRI images. The system provides a computer model of cardiac conduction and programmed stimulation in anatomically correct 3D MRI reconstructions of the left ventricular (LV) normal and infarcted zones and determines whether substrate exists for VT.

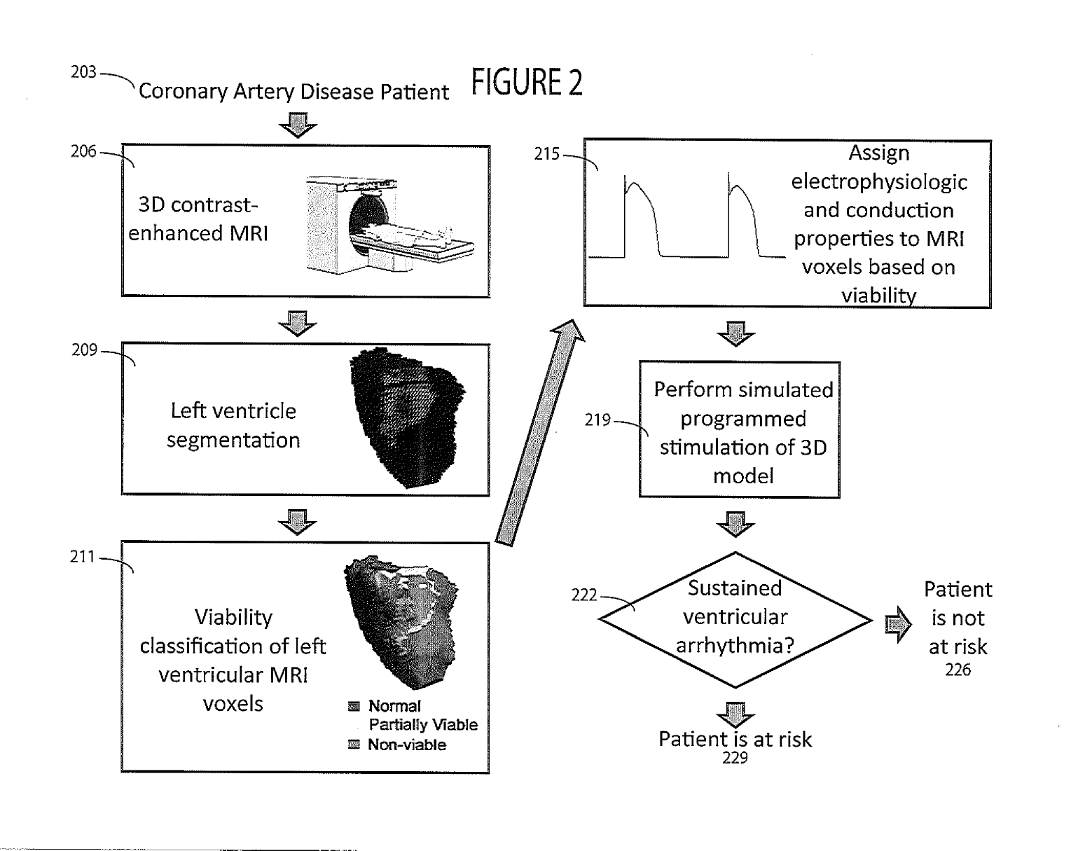

FIG. 2 shows a flowchart of a process performed by a cardiac function analysis system to identify patient cardiac function risk. A coronary artery disease patient 203 is imaged in step 206 using MR imaging device 19 using 3D contrast enhanced MRI. In exemplary operation, MI is induced by coronary artery occlusion in seven pigs. Cardiac MRIs are obtained from each pig in-vivo using 3D Phase Sensitive Inversion Recovery after gadolinium administration. Scar tissue is identified as hyper-enhanced areas (having luminance intensity greater than 3 standard deviations than that of normal myocardium) using variable luminance thresholds to separate impaired myocardium from non-viable scar tissue. In exemplary operation, a closed chest coronary occlusion protocol is applied to obtain myocardial infarction in seven pigs. A percutaneous femoral approach is used to position an angioplasty balloon catheter into the left anterior descending coronary artery just distal to the second diagonal branch. After the balloon is inflated for 30 seconds, 300 mL of agarose gel beads (diameter of 75 to 150 mm; Bio-Rad Laboratories) diluted in 1.5 mL saline are injected through the balloon lumen to permanently occlude the artery. The balloon is deflated and withdrawn. The pigs are allowed 6 to 8 weeks to recover. (The experimental protocol was approved by the Animal Care and Use Committee of Northwestern University).

Following the 6 to 8 week recovery period, cardiac MRI images are obtained from the pigs under general anesthesia using a whole-body Siemens 3.0 Tesla Trio MRI scanner. A free-breathing 3D phase sensitive inversion-recovery (PSIR) turbo FLASH pulse sequence is used for acquisition. PSIR reconstruction is utilized to eliminate the need for precise setting of inversion time and parallel imaging is employed to improve acquisition speed. Image data is collected during free breathing by synchronizing image acquisition to the respiratory cycle using a crossed slice navigator. This method provides near isotropic spatial resolution with voxel sizes of 1.8×1.9×1.8 mm. Images are acquired approximately 15 to 20 minutes after an intravenous injection of contrast (0.2 mmol/kg of gadopentetate dimeglumine, Magnevist, Bayer HealthCare).

In step 209, image processor 29 advantageously performs image processing of MRI data by filtering three-dimensional image data voxels with a 3×3×3 median filter to improve signal-to-noise ratio. Image data regions corresponding to the left ventricle are manually segmented (in another embodiment this may be done automatically using a known segmentation function). The segmented data is linearly interpolated for a resulting resolution of 0.6×0.63×0.6 mm. In step 211, image data processor 29 advantageously classifies the viability of individual voxels of the left ventricle as normal, impaired, and non-viable. An enhanced scar tissue area is manually selected (or automatically selected in another embodiment) in a three-dimensional left ventricle. The selected area is overestimated to include normal regions at boundaries of the scar tissue. The non-selected area is classified by processor 29 as normal myocardium. Processor 29 also calculates mean and standard deviation of luminance intensities in the normal region. Within the selected scar tissue region, processor 29 classifies voxels with luminance intensity values less than the calculated mean plus three standard deviations of the intensities of the selected normal myocardium as viable. A second threshold is used to determine whether remaining voxels are classified as partially viable or non-viable.

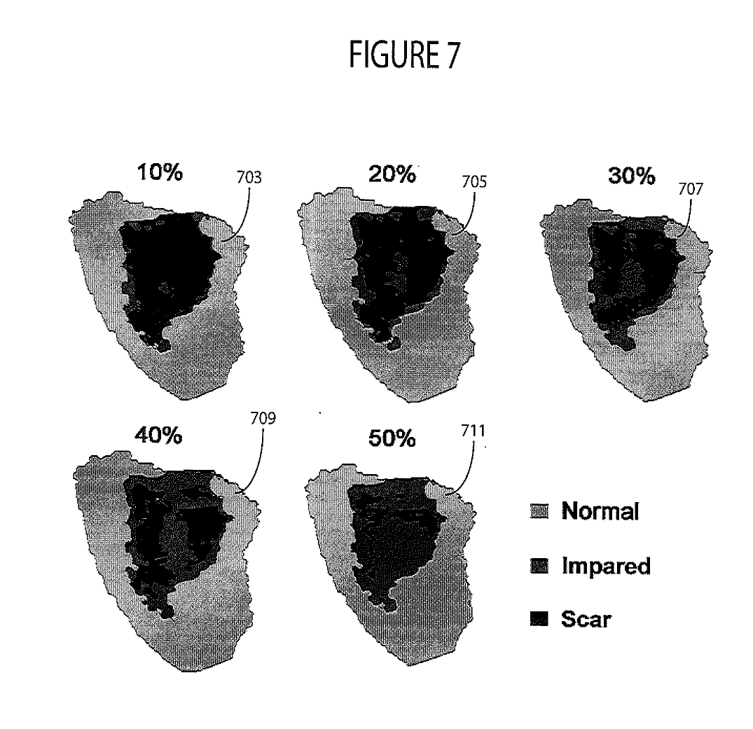

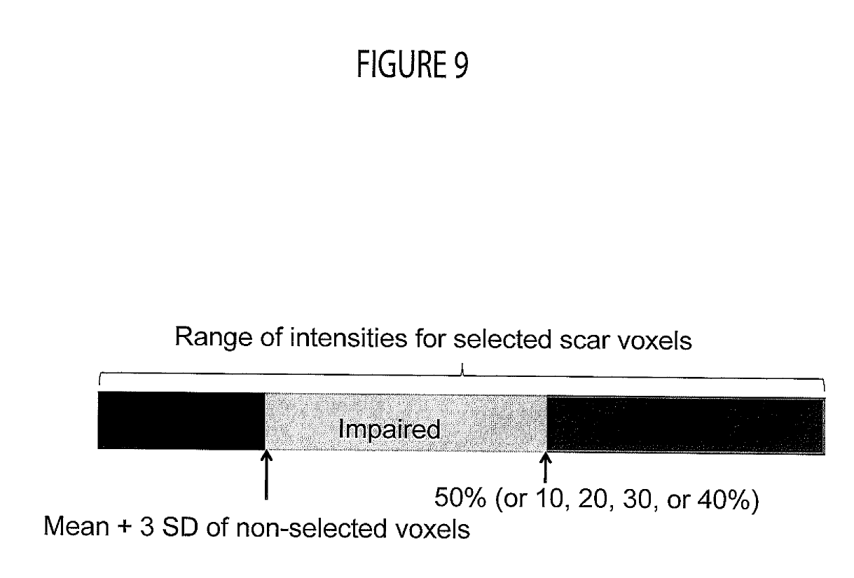

FIG. 7 shows voltage maps of voxels of scar tissue classified by processor 29 using different tissue viability thresholds. Specifically, images 703, 705, 707, 709 and 711 are classified using luminance intensity values of 10, 20, 30, 40 and 50% of the range bounded by the upper viability threshold of the normal myocardium on the lower end and the maximum luminance intensity on the upper end. Images 703, 705, 707, 709 and 711 show how the distribution of partially viable myocardium increases relative to the non-viable scar as the viability threshold value is increased from 10% to 50%. FIG. 9 depicts thresholds used within a range of luminance intensities for image processing and detecting selected scar tissue voxels. Scar tissue is identified as hyper-enhanced areas in a medical image greater than 3 standard deviations from normal myocardium luminance level and tissue viability thresholds are used comprising 10, 20, 30, 40 and 50%, for example of the range bounded by the upper viability threshold of the normal myocardium on the lower end and the maximum luminance intensity on the upper end.

Continuing with FIG. 2, in step 215 model processor 15 uses a voltage action potential model (e.g., a Fenton-Karma model) to simulate activation and conduction in the viable zones of the 3D LV geometry. Processor 15 provides a model of the patient heart using the imaging data and by allocating electrical properties to individual (or groups) of voxels determining electrical conductivity associated with image areas classified as (a) scar tissue, (b) impaired heart tissue and (c) normal heart tissue. The electrical properties allocated to scar tissue, partially viable tissue and normal tissue are mutually different. Processor 15 in one embodiment uses a three variable mathematical model of the ventricular action potential first described by Fenton and Karma (Vortex dynamics in three-dimensional continuous myocardium with fiber rotation: Filament instability and fibrillation, Chaos, 1998; 8:20-47) for the simulations. The Fenton and Karma model approximates the ionic currents of the action potential using three composite currents: a fast inward current, a slow inward current, and a slow outward current. Two different sets of parameters for this model are used depending on whether the myocardium is classified as normal or partially viable.

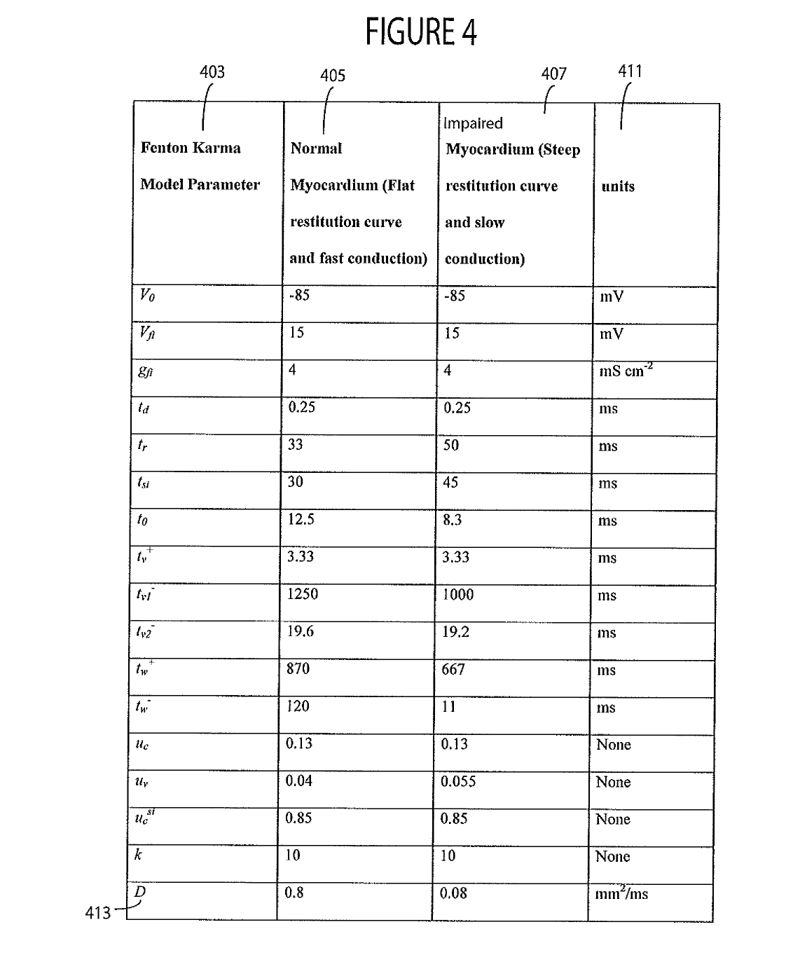

FIG. 4 shows a table including parameters for a Fenton-Karma Model assigned to normal and impaired myocardium. Column 405 shows Model variable values assigned to normal myocardium, column 407 shows Model variable values assigned to impaired myocardium, column 403 identifies the variables and column 411 identifies their corresponding units. Voxels classified by processor 29 to comprise normal myocardium are assigned variables shown in column 403, by model processor 15 that produce a restitution curve where action potential duration gradually increases with diastolic interval. The voxels that are classified by processor 29 as partially viable myocardium are assigned variables shown in column 407 that produce a restitution curve in which action potential durations are stable except for very low diastolic intervals, where the curve is steep. The partially viable myocardium are assigned a steeper restitution curve based on experimental observations showing that greater maximum slopes are present in the epicardial border zones of healed myocardial infarction.

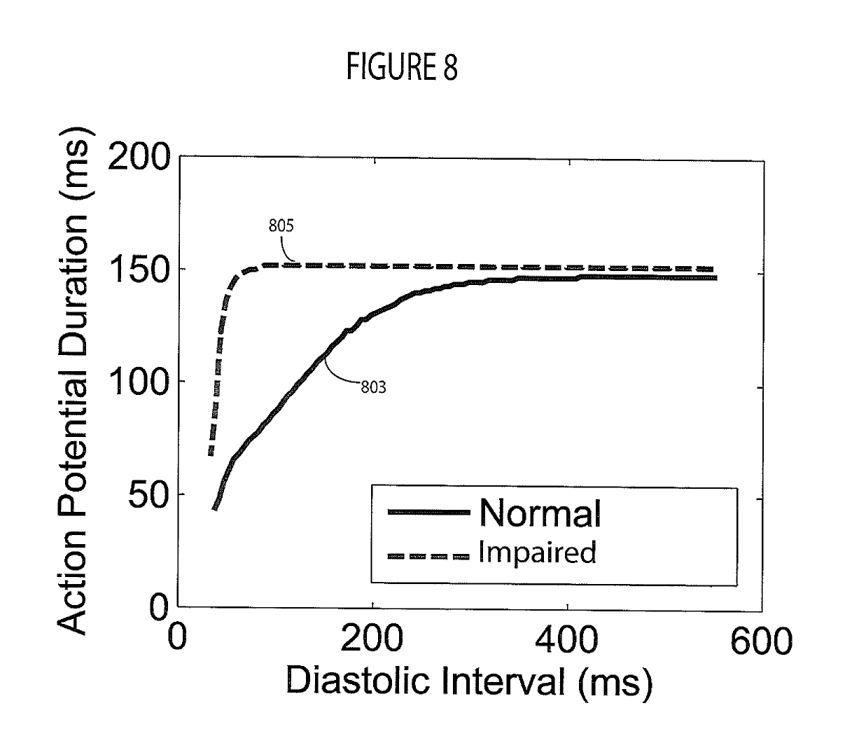

FIG. 8 shows a graph of restitution curves comprising action potential duration plotted against diastolic interval for simulated electrophysiology. Specifically curve 803 shows a restitution curve for normal myocardium and curve 805 shows a restitution curve for partially viable myocardium. In addition to differing restitution curves, the two grades of viability are assigned with different diffusion constants, D (item 413 FIG. 4). The diffusion constant controls the conductivity of the myocardium. A value of D of 0.8 mm³/ms, which is assigned to completely viable myocardium, corresponds to a conduction velocity of 0.85 m/s for a spatial resolution of 0.6 mm. A value of D of 0.08 mm²/ms, which is assigned to the partially viable myocardium, corresponds to a conduction velocity of 0.21 m/s.

In step 219, stimulation processor 20 simulates electrical stimulation of a subject heart using the model to identify risk of heart impairment. In one embodiment the model is generated using data acquired by non-contact mapping on a subject (e.g. patient or animal such as a pig) is performed using a commercial system (such as EnSite 3000, Endocardial Solutions, Inc., St, Paul, Minn., USA) which records signals from a 64-electrode array mounted on a 9Fr catheter positioned in the left ventricle (LV) via a retrograde aortic approach. The commercial system creates a three-dimensional geometry on which sequential isopotential maps constructed from 30,000 virtual electrograms are displayed. Attempts to induce ventricular tachycardia are performed by programmed simulation in the right ventricular apical septum and in the left ventricle, for example. The signals of any induced tachycardias are saved for offline dynamic substrate mapping to determine arrhythmia characteristics and scar tissue exit sites. In an implementation, simulations are performed on Lenovo D10 workstations equipped with a dual-processor motherboard and two Intel Xeon Quad Core processors with clock speeds of 3.16 GHz. The action potential simulations of the left ventricle are equally divided into eight equal regions and processed in parallel with the eight total processor cores.

Simulated Arrhythmia induction is performed for individual left ventricular models at each of the luminance intensity (tissue viability) thresholds for myocardial viability (10-50%). Arrhythmia induction is also performed for individual left ventricular models assuming uniformly viable myocardium voxels. The pacing protocol consisted of three beats at times 0, 200 ms, and 300 ms with pulse width of 2 ms, for example. Stimulation is performed in the left ventricle at one basal site, one apical site, and one midpoint site between base and apex but may be performed at other user selected sites. The nature of induced arrhythmia is noted (ventricular tachycardia vs. ventricular fibrillation). An arrhythmia is considered sustained if it lasts at least 5 seconds. A simulated paced beat and a timed extra-stimulus are applied near the scar tissue to induce VT. The maximum conduction velocity (CV) that allows for induction of VT is determined. Inducibility is also tested in the pigs via actual electrophysiolgic study (EPS). In response to determining in step 222 that stimulation results in a sustained ventricular arrhythmia, a message is generated in step 229 by processor 20 indicating a subject is at risk. In response to determining in step 222 that stimulation does not result in a sustained ventricular arrhythmia, a message is generated in step 226 by processor 20 indicating a subject is not at risk.

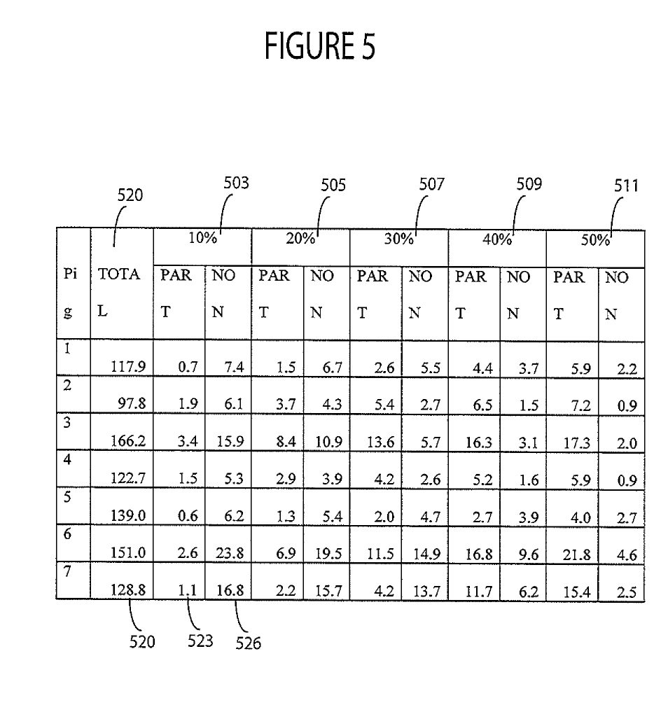

FIG. 5 shows a table including result data determined for the seven pigs indicating total volume of left ventricular myocardium (column 520), volume of impaired myocardium (e.g. column 523) and volume of completely non-viable scar tissue (e.g. column 526) derived by image data processor 29 using a 10% (503) luminance intensity (tissue viability) threshold. The table similarly includes columns indicating volume of impaired myocardium and volume of completely non-viable scar tissue derived by image data processor 29 using 20% (505), 30%, (507), 40% (509) and 50% (511) luminance intensity (tissue viability) thresholds, respectively. In the seven subject pigs, left ventricular myocardium as determined by MR imaging has total volumes ranging from 97.8 to 166.2 cm³. The infarct volumes when considering both impaired and non-viable areas comprise 4.9 to 17.5% of the total left ventricular myocardium volume.

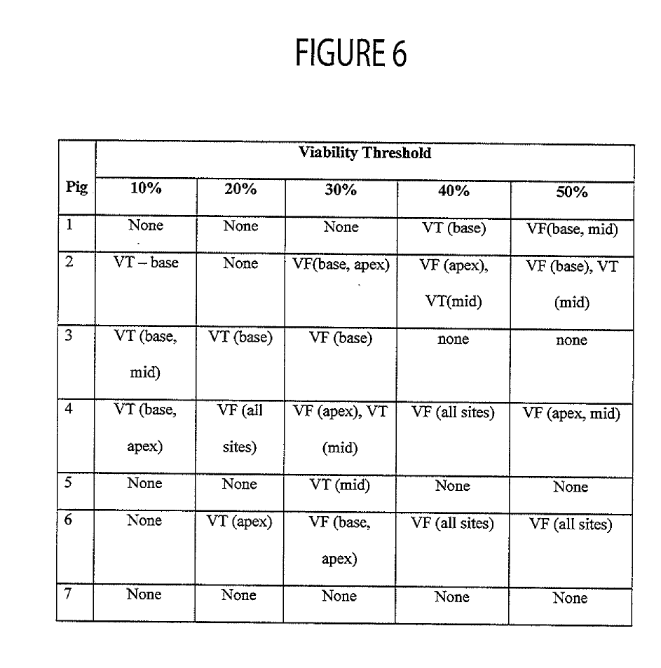

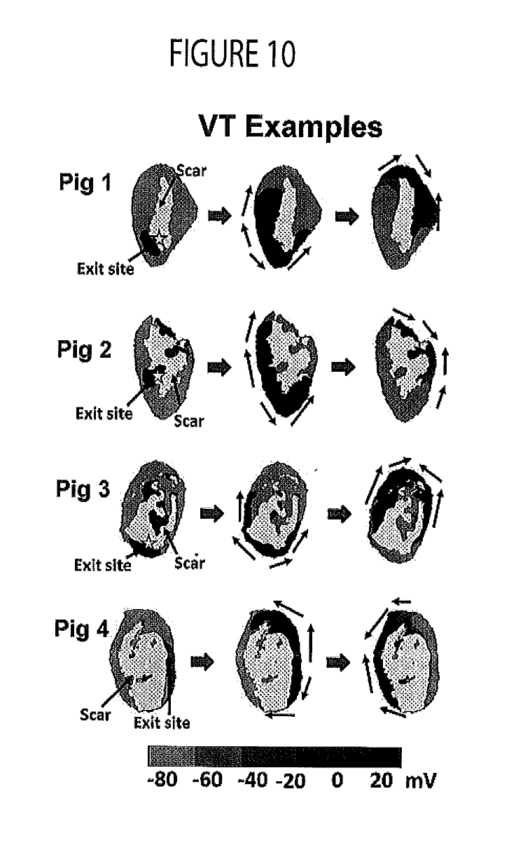

FIG. 6 shows a table indicating results of analysis of MR imaging data acquired during stimulation of tissue for viability testing of the seven pigs. The results are provided by tissue classification by processor 29 using different viability thresholds, specifically, luminance intensity tissue viability threshold values of 10, 20, 30, 40 and 50%. The table lists episodes and corresponding site of stimulation which resulted in an arrhythmia lasting at least 5 seconds. Ventricular tachycardias characterized by monomorphic waveforms in the pseudo-ECG were induced in six of the seven pigs. FIG. 10 shows corresponding voltage maps indicating induced ventricular tachycardia resulting from electrophysiologic testing of four test subject pigs. Ventricular fibrillation characterized by changing morphologies in the ECG throughout the 5 second simulation is induced in the pigs.

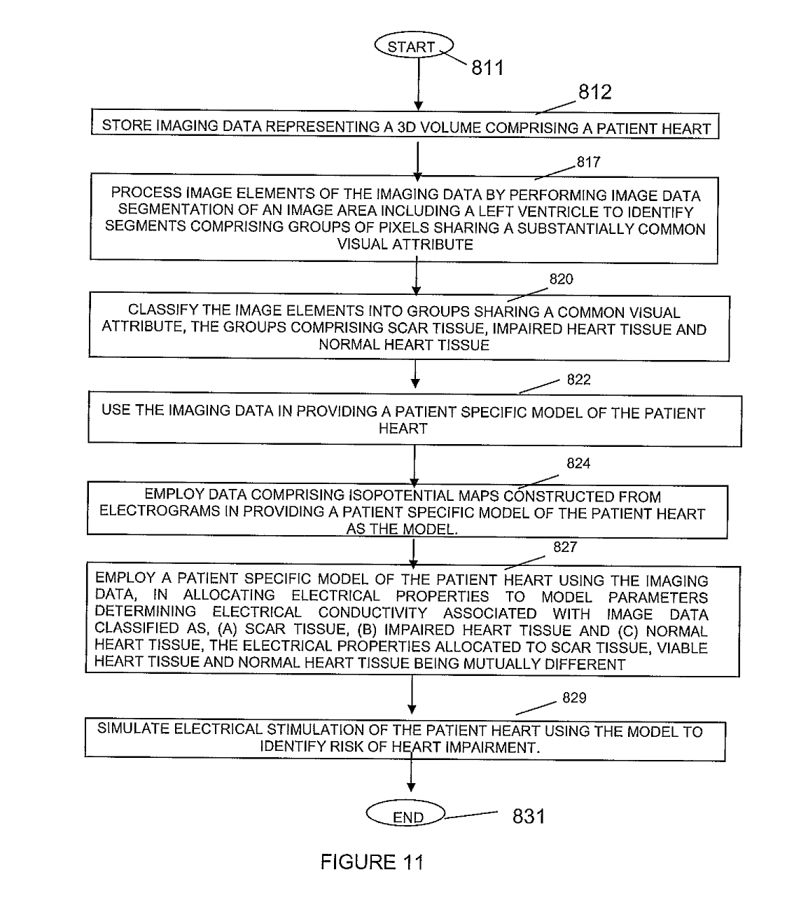

FIG. 11 shows a flowchart of a process performed by cardiac function analysis system 10. In step 812 following the start at step 811, image data processor 29 stores imaging data representing a 3D volume comprising a patient heart. In one embodiment, the imaging data is acquired by MR imaging device 19. The imaging data represents a 3D volume comprising a patient heart acquired by MR imaging device 19. In step 817, image data processor 29 automatically processes image elements of the imaging data by performing image data segmentation of an image area including a left ventricle to identify segments comprising groups of pixels sharing a substantially common visual attribute. The image elements comprise at least one of pixels or volume image elements voxels. Image data processor 29 in step 820, automatically classifies the image elements into groups sharing a common visual attribute and comprising scar tissue, viable heart tissue and normal heart tissue. The common visual attribute comprises at least one of, (a) shade, (b) color, (c) luminance intensity and (d) texture. In one embodiment, processor 29 classifies a group as pixels having luminance intensity exceeding a predetermined luminance threshold or lying within a predetermined luminance range.

In step 822, processor 29 uses the imaging data in providing a patient specific model of the patient heart and in step 824 employs data comprising isopotential maps constructed from electrograms, e.g., derived by non-contact mapping, in providing a patient specific model of the patient heart as the model. Model processor 15 in step 827, employs a patient specific model of the patient heart using the imaging data, in automatically allocating electrical properties to model parameters determining electrical conductivity associated with image data classified as, (a) scar tissue, (b) impaired heart tissue and (c) normal heart tissue. In one embodiment, the model comprises a Fenton-Karma compatible computer action potential model. The electrical properties allocated to scar tissue, viable heart tissue and normal heart tissue are individually and mutually different. In step 829, stimulation processor 20 automatically simulates electrical stimulation of the patient heart using the model to identify risk of heart impairment and image data processor 29 determines whether a sustained ventricular arrhythmia is initiated in the model of the patient heart in response to the simulated electrical stimulation of the patient heart. The process of FIG. 11 terminates at step 831.

A processor as used herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and is conditioned using executable instructions to perform special purpose functions not performed by a general purpose computer. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A graphical user interface (GUI), as used herein, comprises one or more display images, generated by a display processor and enabling user interaction with a processor or other device and associated data acquisition and processing functions.

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps herein may be performed automatically or wholly or partially in response to user command. An activity (including a step) performed automatically is performed in response to executable instruction or device operation without user direct initiation of the activity.

The system and processes of FIGS. 1-11 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. The system automatically identifies risk for rapid, potentially dangerous heart rhythms and myocardial infarctions by simulation of ventricular tachycardia circuits using in-vivo MRI and a simplified computer model of cardiac electrophysiology for non-invasive risk stratification for sudden cardiac death. Further, the processes and applications may, in alternative embodiments, be located on one or more (e.g., distributed) processing devices on a network linking the units of FIG. 1. Any of the functions and steps provided in FIGS. 1-11 may be implemented in hardware, software or a combination of both.

What is claimed is:

1. A cardiac function analysis system, comprising;
a repository of imaging data representing a 3D volume comprising a patient heart;
a model processor for providing a model of said patient heart using said imaging data, said model being for use in allocating electrical properties to model parameters determining electrical conductivity associated with image classified as,
(a) scar tissue and
(b) normal heart tissue, said electrical properties allocated to scar tissue being different to electrical properties allocated to normal tissue; and
a stimulation processor for simulating electrical stimulation of said patient heart using said model to identify risk of heart impairment.

2. A system according to claim 1, wherein
said normal heart tissue comprise normal and impaired heart tissue and
said model processor allocates different electrical properties associated with electrical conductivity to, scar tissue, viable heart tissue and normal heart tissue.

3. A system according to claim 1, wherein
said model processor uses said imaging data in providing a patient specific model of said patient heart.

4. A system according to claim 1, wherein
said model processor uses data comprising isopotential maps constructed from electrograms in providing a patient specific model of said patient heart as said model.

5. A system according to claim 1, including
an image data processor processes image elements of said imaging data by classifying said image elements to identify image elements comprising said scar tissue and said normal heart tissue.

6. A system according to claim 5, wherein
said image elements comprise at least one of (a) pixels and (b) voxels.

7. A system according to claim 5, wherein
said image data processor processes image elements of said imaging data by classifying said image elements to identify image elements comprising viable heart tissue.

8. A system according to claim 5, wherein
said image data processor processes image elements of said imaging data by performing image data segmentation of an area including a left ventricle to identify segments comprising groups of pixels sharing a substantially common visual attribute, said groups comprising (a) scar tissue, (b) impaired tissue and (c) normal heart tissue.

9. A system according to claim 8, wherein
said common visual attribute comprises at least one of, (a) shade, (b) color, (c) luminance intensity and (d) texture and
said image data processor classifies a group as pixels having luminance intensity exceeding a predetermined luminance threshold or lying within a predetermined luminance range.

10. A system according to claim 8, wherein
said image data processor classifies said image elements into groups sharing a common visual attribute.

11. A system according to claim 1, including
an image data processor processes image elements of said imaging data by classifying said image elements to identify image elements comprising (a) tissue fiber orientation and (b) body cavity wall location.

12. A system according to claim 1, wherein
said model processor allocates electrical properties to model parameters determining electrical conductivity associated with image data classified by, (a) tissue fiber orientation and (b) body cavity wall location.

13. A system according to claim 1, wherein
said model processor allocates electrical properties to model parameters determining electrical conductivity associated with image data classified by specialized imaging functions including at least one of (a) cell imaging, (b) gap junction imaging and (c) MIBG imaging using meta-iodobenzylguanidine (mIBG).

14. A system according to claim 1, wherein
said image data processor determines whether a sustained ventricular arrhythmia is initiated in said model of said patient heart in response to said simulated electrical stimulation of said patient heart.

15. A system according to claim 1, wherein
said imaging data representing a 3D volume comprising a patient heart is acquired by an MR imaging device.

16. A cardiac function analysis system, comprising:
a repository of imaging data representing a 3D volume comprising a patient heart;
an image data processor for processing image elements of said imaging data by performing image data segmentation of an image area including a left ventricle to identify segments comprising groups of pixels sharing a substantially common visual attribute and by classifying said image elements into groups sharing a common visual attribute, said groups comprising scar tissue, impaired tissue, and normal heart tissue;
a model processor for providing a model of said patient heart using said imaging data, said model being for use in allocating electrical properties to model parameters determining electrical conductivity associated with image data classified as,
(a) scar tissue,
(b) impaired tissue and
(c) normal heart tissue, said electrical properties allocated to scar tissue being different to electrical properties allocated to normal tissue; and
a stimulation processor for simulating electrical stimulation of said patient heart using said model to identify risk of heart impairment.

17. A system according to claim 16, wherein
said image data processor determines whether a sustained ventricular arrhythmia is initiated in said model of said patient heart in response to said simulated electrical stimulation of said patient heart.

18. A system according to claim 16, wherein
said common visual attribute comprises at least one of, (a) shade, (b) color, (c) luminance intensity and (d) texture.

19. A system according to claim 16, wherein
said normal heart tissue comprise normal and viable heart tissue and
said model processor allocates different electrical properties associated with electrical conductivity to, scar tissue, viable heart tissue and normal heart tissue.

20. A system according to claim 16, wherein
said model is a Fenton-Karma compatible computer action potential model.

21. A cardiac function analysis method, comprising the activities of
storing imaging data representing a 3D volume comprising a patient heart;
processing image elements of said imaging data by performing image data segmentation of an image area including a left ventricle to identify segments comprising groups of pixels sharing a substantially common visual attribute;
classifying said image elements into groups sharing a common visual attribute, said groups comprising scar tissue and normal heart tissue;
employing a model of said patient heart derived using said imaging data, said model being for use in allocating electrical properties to model parameters determining electrical conductivity associated with image data classified as,
(a) scar tissue,
(b) impaired tissue and
(c) normal heart tissue, said electrical properties allocated to scar tissue being different to electrical properties allocated to normal tissue; and
simulating electrical stimulation of said patient heart using said model to identify risk of heart impairment.

22. A method according to claim 21, wherein
said normal heart tissue comprise normal and viable heart tissue and including the activity of allocating different electrical properties to model parameters associated with electrical conductivity of scar tissue, impaired heart tissue and normal heart tissue.

23. A system according to claim 21, including the activity of
using said imaging data in providing a patient specific model of said patient heart.

24. A system according to claim 21, wherein
employing data comprising isopotential maps constructed from electrograms in providing a patient specific model of said patient heart as said model.
